(19) United States
(12) Patent Application Publication
(10) Pub. No.: US 2017/0201915 A1
(43) Pub. Date: Jul. 13, 2017

(54) HANDOVER METHOD, HANDOVER APPARATUS AND HANDOVER SYSTEM

(71) Applicant: Nokia Solutions and Networks Oy, Espoo (FI)

(72) Inventors: Guillaume DECARREAU, Munich (DE); Benoist Pierre SEBIRE, Tokyo (JP); Yanji ZHANG, Beijing (CN)

(21) Appl. No.: 15/326,845

(22) PCT Filed: Jul. 30, 2014
(86) PCT No.: PCT/CN2014/083283

§ 371 Date: Jan. 17, 2017

(51) Int. Cl. H04W 36/00; H04W 8/22

(52) U.S. Cl. CPC H04W 36/0083; H04W 36/0061; H04W 8/22

(57) ABSTRACT

There is provided a method comprising receiving first information at a user equipment, said first information indicative of whether a first cell supports the user equipment and starting a connection procedure to the first cell if the first information indicates that the first cell supports the user equipment, after receiving the first information.

The present application relates to a method, apparatus and system and in particular but not exclusively, to inter RAT mobility for low cost UEs.

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communications may comprise, for example, communication of data for carrying communications such as voice, electronic mail (email), text message, multimedia and/or content data and so on. Non-limiting examples of services provided include two-way or multi-way calls, data communication or multimedia services and access to a data network system, such as the Internet.

In a wireless communication system at least a part of communications between at least two stations occurs over a wireless link. Examples of wireless systems include public land mobile networks (PLMN), satellite based communication systems and different wireless local networks, for example wireless local area networks (WLAN). The wireless systems can typically be divided into cells, and are therefore often referred to as cellular systems.

A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. An example of attempts to solve the problems associated with the increased demands for capacity is an architecture that is known as the long-term evolution (LTE) of the Universal Mobile Telecommunications System (UMTS) radio-access technology. The LTE is being standardized by the 3^{rd} Generation Partnership Project (3GPP). The various development stages of the 3GPP LTE specifications are referred to as releases.

In a first aspect there is provided a method comprising receiving first information at a user equipment, said first information indicative of whether a first cell supports the user equipment and starting a connection procedure to the first cell if the first information indicates that the first cell supports the user equipment, after receiving the first information.

Starting a connection procedure may comprise performing a random access procedure. The user equipment may be connected to a source cell and the first cell may be a target cell. The method may comprise receiving a handover request from a node of the source cell to handover to the target cell.

The method may comprise receiving the first information as part of the handover request.

The first information may comprise a bit or a flag in the handover request.

The method may comprise receiving a measurement request for the first cell and reporting measurements if said first information indicates that the first cell supports the user equipment, after receiving the first information.

Receiving the first information may comprise reading a system information block of the first cell.

The information may comprise a bit or a flag in the system information block.

In a second aspect there is provided a method comprising receiving first information at a user equipment, said first information indicative of whether a first cell supports the user equipment and operating the user equipment in idle mode if the first information indicates that the first cell does not support the user equipment, after receiving the first information.

The user equipment may be connected to a source cell and the first cell may be a target cell.

The method may comprise receiving a handover request from a node of the source cell to handover to the target cell.

The method may comprise receiving the first information as part of the handover request.

The first information may comprise a bit or a flag in the handover request.

The method may comprise receiving a measurement request for the first cell and reporting lowest possible quality for the first cell if said first information indicates that the first cell does not support the user equipment, after receiving the first information.

Receiving the first information may comprise reading a system information block of the first cell.

The information may comprise a bit or a flag in the system information block.

The method may comprise, when a user equipment connects to a second cell, causing second information to be sent to the second cell, said second information indicative of first cell identity.

In a third aspect there is provided a method comprising receiving a measurement request for a first cell at a user equipment, receiving first information at the user equipment, said first information indicative of whether the first cell supports the user equipment and causing measurements for the first cell to be reported if said first information indicates that the first cell supports the user equipment, after receiving the first information.

The user apparatus may be connected to a second cell.

Receiving the first information may comprise reading a system information block of the first cell.

In a fourth aspect there is provided a method comprising receiving a measurement request for a first cell at a user equipment, receiving first information at the user equipment, said first information indicative of whether the first cell supports the user equipment and causing lowest possible quality for the first cell to be reported if said first information indicates that the first cell does not support the user equipment, after receiving the first information.

The user apparatus may be connected to a second cell.

Receiving the first information may comprise reading a system information block of the first cell.

In a fifth aspect there is provided an apparatus said apparatus comprising means for receiving first information at a user equipment, said first information indicative of whether a first cell supports the user equipment and starting a connection procedure to the first cell if the first information indicates that the first cell supports the user equipment, after receiving the first information.

Means for starting a connection procedure may comprise means for performing a random access procedure.

The user equipment may be connected to a source cell and the first cell may be a target cell.

The apparatus may comprise means for receiving a handover request from a node of the source cell to handover to the target cell.

The apparatus may comprise means for receiving the first information as part of the handover request.

The first information may comprise a bit or a flag in the handover request.

The apparatus may comprise means for receiving a measurement request for the first cell and reporting measurements if said first information indicates that the first cell supports the user equipment, after receiving the first information.

Means for receiving the first information may comprise means for reading a system information block of the first cell.

The information may comprise a bit or a flag in the system information block.

In a sixth aspect there is provided an apparatus, said apparatus comprising means for receiving first information at a user equipment, said first information indicative of whether a first cell supports the user equipment and means for operating the user equipment in idle mode if the first information indicates that the first cell does not support the user equipment, after receiving the first information.

The user equipment may be connected to a source cell and the first cell may be a target cell.

The apparatus may comprise means for receiving a handover request from a node of the source cell to handover to the target cell.

The apparatus may comprise means for receiving the first information as part of the handover request.

The first information may comprise a bit or a flag in the handover request.

The apparatus may comprise means for receiving a measurement request for the first cell and reporting lowest possible quality for the first cell if said first information indicates that the first cell does not support the user equipment, after receiving the first information.

Means for receiving the first information may comprise means for reading a system information block of the first cell.

The information may comprise a bit or a flag in the system information block.

The apparatus may comprise means for, when a user equipment connects to a second cell, causing second information to be sent to the second cell, said second information indicative of first cell identity.

In a seventh aspect there is provided an apparatus, said apparatus comprising means for receiving a measurement request for a first cell at a user equipment, means for receiving first information at the user equipment, said first information indicative of whether the first cell supports the user equipment and means for causing measurements for the first cell to be reported if said first information indicates that the first cell supports the user equipment, after receiving the first information.

The user apparatus may be connected to a second cell.

Means for receiving the first information may comprise means for reading a system information block of the first cell.

In an eighth aspect there is provided an apparatus, said apparatus comprising means for receiving a measurement request for a first cell at a user equipment, means for receiving first information at the user equipment, said first information indicative of whether the first cell supports the user equipment and means for causing lowest possible quality for the first cell to be reported if said first information indicates that the first cell does not support the user equipment, after receiving the first information.

The user apparatus may be connected to a second cell.

Means for receiving the first information may comprise means for reading a system information block of the first cell.

In a ninth aspect there is provided an apparatus comprising at least one processor; and at least one memory including computer program code; the at least one memory and the computer program code configured to, with the at least one processor, cause the apparatus at least to: receive first information at a user equipment, said first information indicative of whether a first cell supports the user equipment and start a connection procedure to the first cell if the first information indicates that the first cell supports the user equipment, after receiving the first information.

The apparatus may be configured to perform a random access procedure.

The user equipment may be connected to a source cell and the first cell may be a target cell.

The apparatus may comprise means for receiving a handover request from a node of the source cell to handover to the target cell.

The apparatus may be configured to receive the first information as part of the handover request.

The first information may comprise a bit or a flag in the handover request.

The apparatus may be configured to receive a measurement request for the first cell and report measurements if said first information indicates that the first cell supports the user equipment, after receiving the first information.

The apparatus may be configured to for reading a system information block of the first cell.

The information may comprise a bit or a flag in the system information block.

In a tenth aspect there is provided an apparatus comprising at least one processor; and at least one memory including computer program code; the at least one memory and the computer program code configured to, with the at least one processor, cause the apparatus at least to: receive first information at a user equipment, said first information indicative of whether a first cell supports the user equipment and operate the user equipment in idle mode if the first information indicates that the first cell does not support the user equipment, after receiving the first information.

The user equipment may be connected to a source cell and the first cell may be a target cell.

The apparatus may be configured to receive a handover request from a node of the source cell to handover to the target cell.

The apparatus may be configured to receive the first information as part of the handover request.

The first information may comprise a bit or a flag in the handover request.

The apparatus may be configured to receive a measurement request for the first cell and report lowest possible quality for the first cell if said first information indicates that the first cell does not support the user equipment, after receiving the first information.

The apparatus may be configured to read a system information block of the first cell.

The information may comprise a bit or a flag in the system information block.

The apparatus may be configured to, when a user equipment connects to a second cell, cause second information to be sent to the second cell, said second information indicative of first cell identity.

In an eleventh aspect there is provided an apparatus comprising at least one processor; and at least one memory including computer program code; the at least one memory and the computer program code configured to, with the at least one processor, cause the apparatus at least to receive a measurement request for a first cell at a user equipment, receive first information at the user equipment, said first information indicative of whether the first cell supports the user equipment and cause measurements for the first cell to be reported if said first information indicates that the first cell supports the user equipment, after receiving the first information.

The user apparatus may be connected to a second cell.

The apparatus may be configured to read a system information block of the first cell.

In a twelfth there is provided an apparatus comprising at least one processor; and at least one memory including computer program code; the at least one memory and the computer program code configured to, with the at least one processor, cause the apparatus at least to: receive a measurement request for a first cell at a user equipment, receive first information at the user equipment, said first information indicative of whether the first cell supports the user equipment and cause lowest possible quality for the first cell to be reported if said first information indicates that the first cell does not support the user equipment, after receiving the first information.

The user apparatus may be connected to a second cell.

The apparatus may be configured to read a system information block of the first cell.

In a thirteenth aspect there is provided a computer program comprising computer executable instructions which when run on one or more processors perform the method of any one of the first to fourth aspects.

In the above, many different embodiments have been described. It should be appreciated that further embodiments may be provided by the combination of any two or more of the embodiments described above.

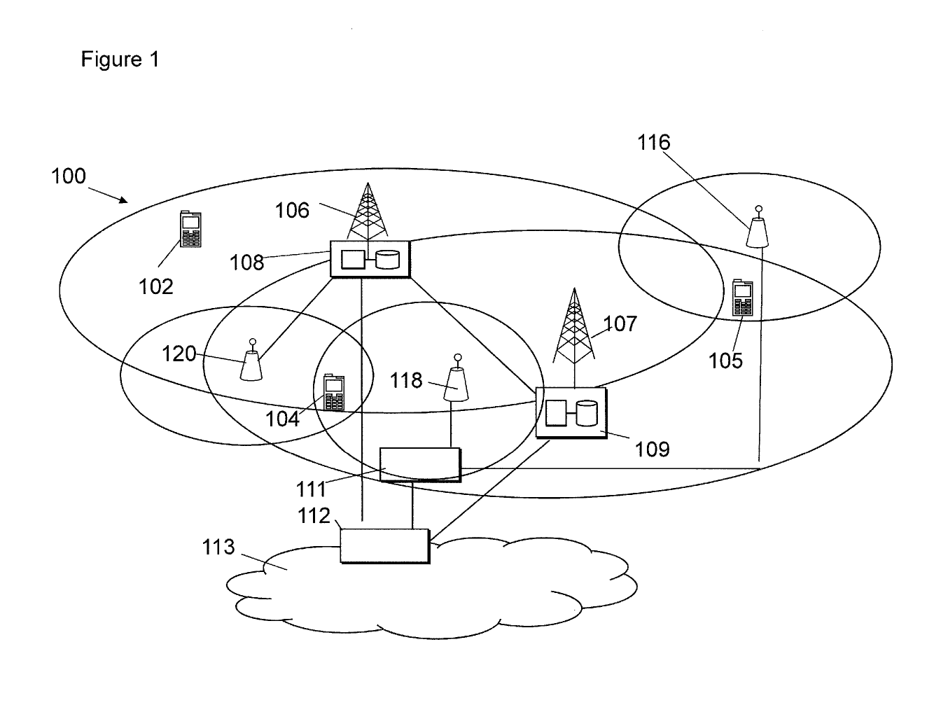

FIG. 1 shows a schematic diagram of an example communication system comprising a base station and a plurality of communication devices;

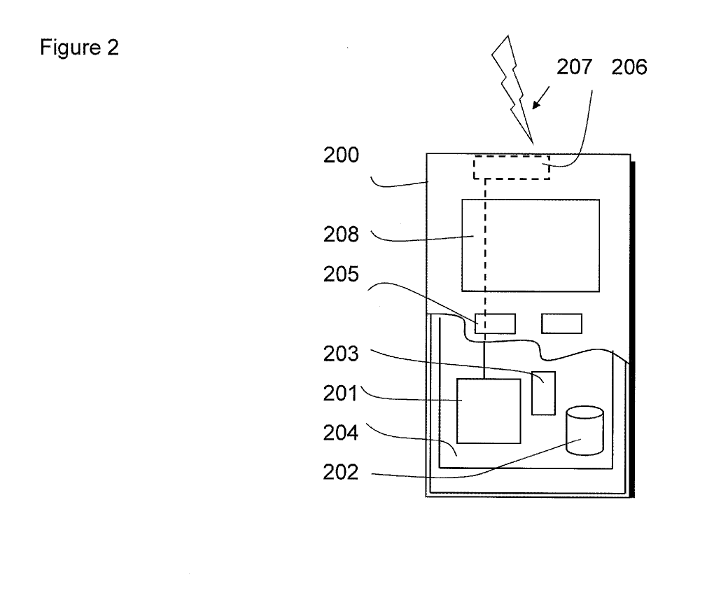

FIG. 2 shows a schematic diagram, of an example mobile communication device;

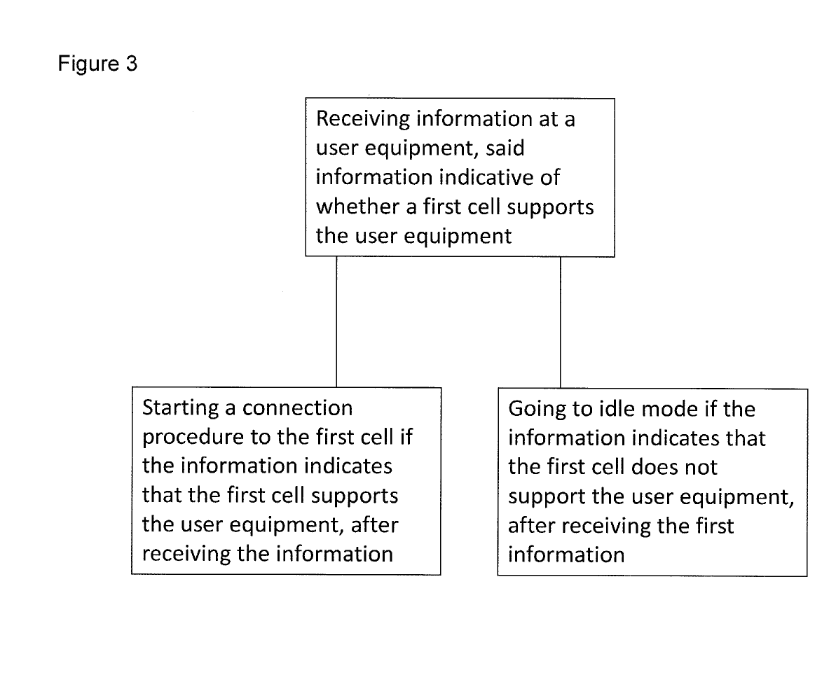

FIG. 3 shows an example method of allowing UEs of a certain category to connect only to cells that support that category

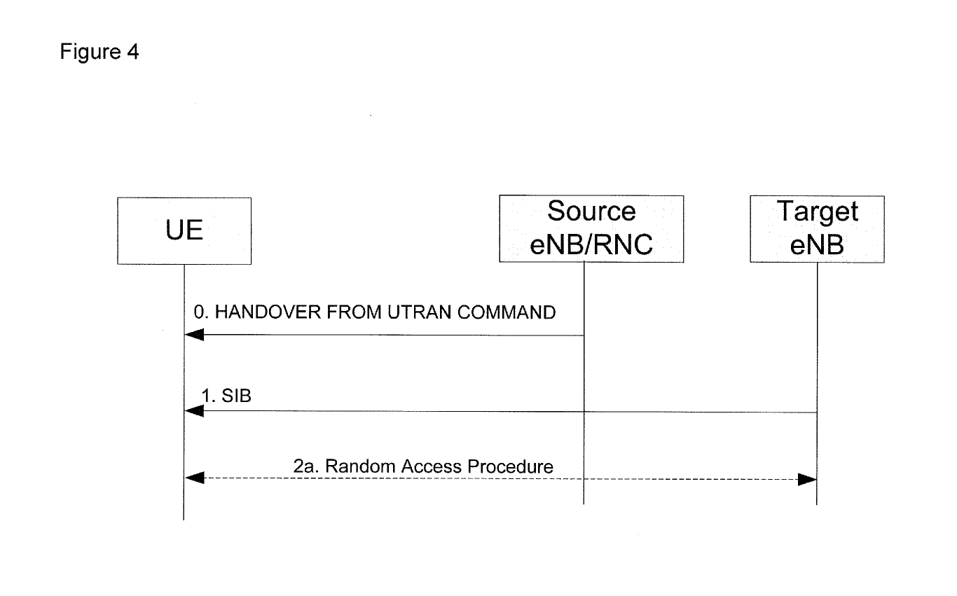

FIG. 4 shows an example timing diagram for implementing a method of the disclosure;

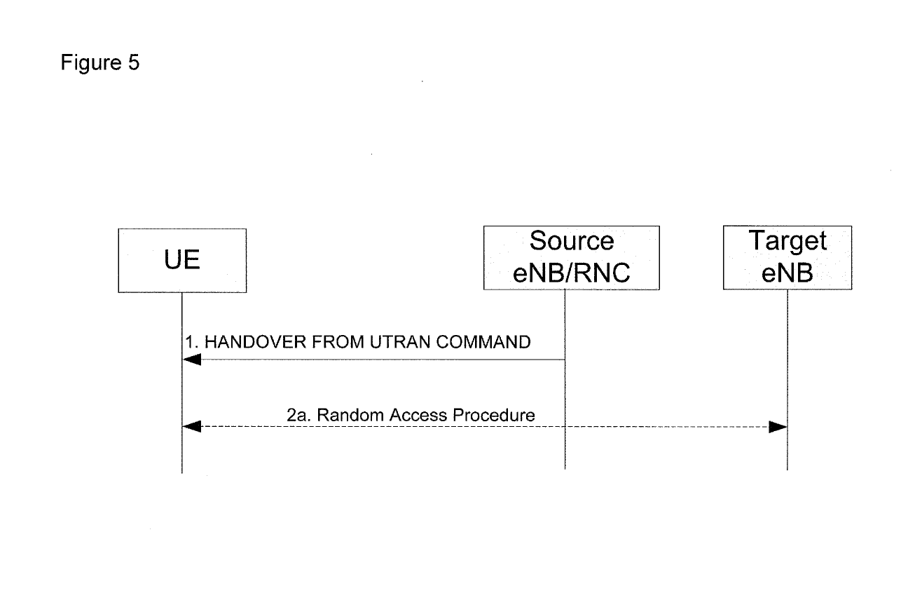

FIG. 5 shows an example timing diagram for implementing a method of the disclosure;

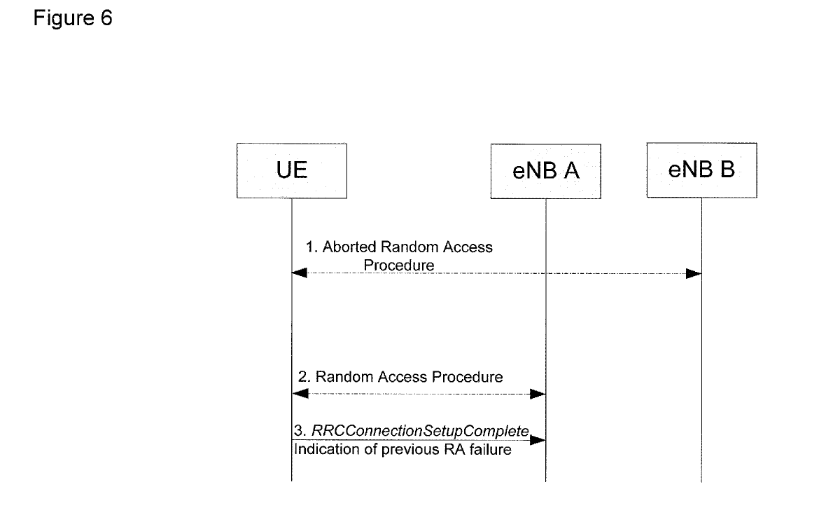

FIG. 6 shows an example timing diagram for implementing a method of the disclosure;

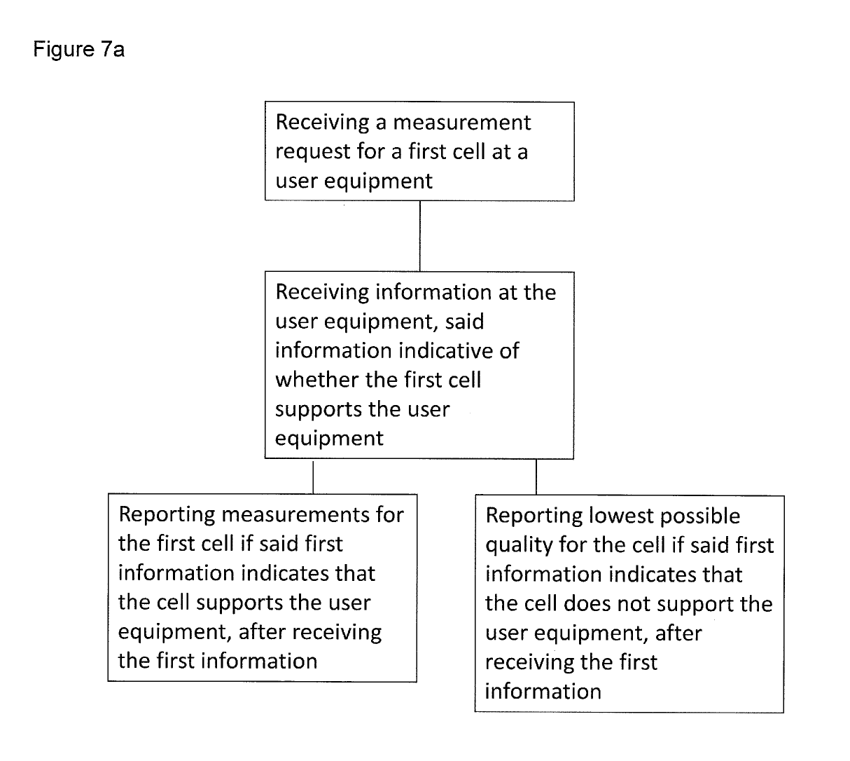

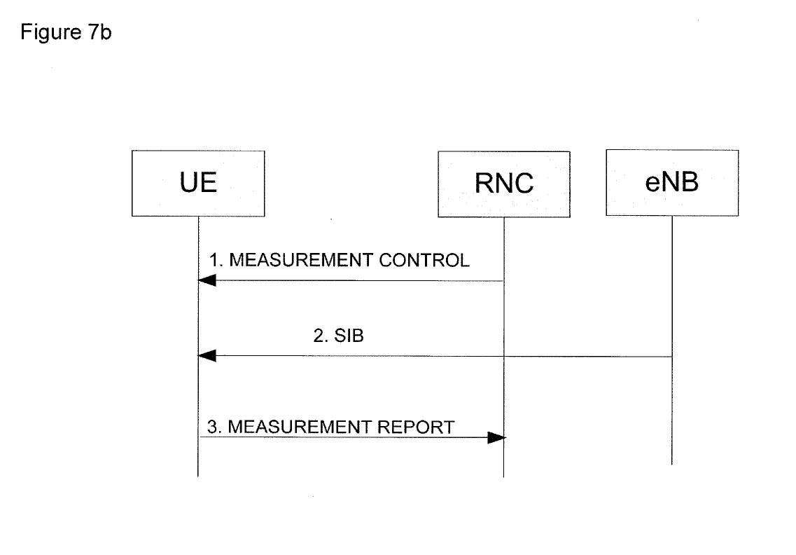

FIG. 7a shows an example method of allowing UEs of a certain category to send measurements for cells that support that category

FIG. 7b shows an example timing diagram for implementing a method of the disclosure;

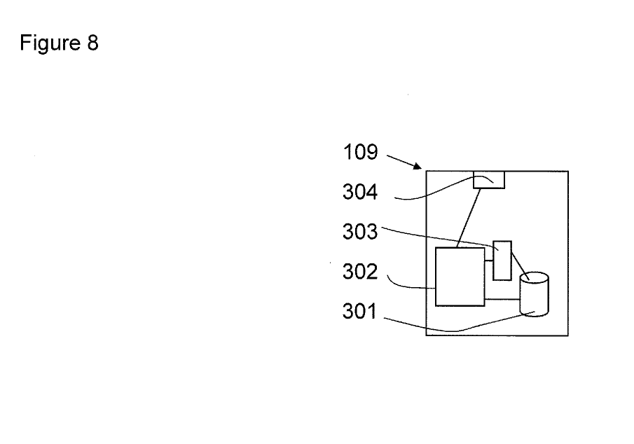

FIG. 8 shows a schematic diagram of an example control apparatus;

Before explaining in detail the examples, certain general principles of a wireless communication system and mobile communication devices are briefly explained with reference to FIGS. 1 to 2 to assist in understanding the technology underlying the described examples.

In a wireless communication system 100, such as that shown in FIG. 1, mobile communication devices or user equipment (UE) 102, 104, 105 are provided wireless access via at least one base station or similar wireless transmitting and/or receiving node or point. The UE may be as shown in FIG. 2, discussed below. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (not shown) and may be implemented as one central apparatus or its functionality may be distributed over several apparatus. The controller apparatus may be part of the base station and/or provided by a separate entity such as a Radio Network Controller (RNC). In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller. The control apparatus may be as shown in FIG. 8 which is discussed later.

LTE systems may however be considered to have a so-called “flat” architecture, without the provision of RNCs; rather the (e)NB is in communication with a system architecture evolution gateway (SAE-GW) and a mobility management entity (MME), which entities may also be pooled meaning that a plurality of these nodes may serve a plurality (set) of (e)NBs. Each UE is served by only one MME and/or S-GW at a time and the (e)NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided.

A possible mobile communication device will now be described in more detail with reference to FIG. 2 showing a schematic, partially sectioned view of a communication device 200. The mobile communication devices or user equipment (UE) 102, 104, 105 in the wireless communication system 100 of FIG. 1 may comprise a communication device 200. Such a communication device is often referred to as user equipment (UE) or terminal. An appropriate mobile communication device may be provided by any device capable of sending and receiving radio signals. Non-limiting examples include a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. Users may also be provided broadcast or multicast data. Non-limiting examples of the content include downloads, television and radio programs, videos, advertisements, various alerts and other information.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced Node Bs (eNBs) and provide E-UTRAN features such as user plane Radio Link Control/Medium Access Control/Physical layer protocol (RLC/MAC/PHY) and control plane Radio Resource Control (RRC) protocol terminations towards the communication devices. Other examples of radio access system include those provided by base stations of systems that are based on technologies such as wireless local area network (WLAN) and/or WiMax (Worldwide Interoperability for Microwave Access). A base station can provide coverage for an entire cell or similar radio service area.

The physical capabilities of a UE may vary. “Low cost” UEs have physical capabilities which are lower than the lowest possible capability in current specifications. For example, the maximum number of bits in a Downlink Transport Block (DL TBS) that a UE is capable of dealing with may be 1000. Such a UE may be defined as a category 0 (Cat. 0) UE.

The physical capability of a UE may affect the UE's compatibility with different networks. For example, a low cost LTE UE may not be compatible with earlier releases of an LTE specification. However the physical capability of a UE for LTE should not affect the UE's compatibility with a UMTS network. A UE of a particular physical capability may be capable of accessing a first type of network, for example UMTS. In this case the UE can start a call in the first network with no restriction. At some point a node, for example a RNC in the case of a UMTS network, may decide to handover the UE to a second network, such as an LTE network. The node may send a handover request message. However, if the second network does not support the UE, unexpected behaviour, such as calls being dropped, may occur if the requirements of the second network are more than the physical capability of the UE, for example if the UE is a Cat. 0 UE and the base station (eNB) schedules more than 1000 bits in a TB to the UE.

Cat. 0 UEs may not be compatible with networks that are built with LTE specification before release 12. In the case of incoming Handover request from UTRAN, a Rel'11 eNB may not detect that a UE is Cat.0 and would erroneously accept the UE, which would cause unpredictable problems after the UE joined the LTE network. It is agreed that an eNB should advertise whether it is capable of supporting a Cat.0 UE and the Cat. 0 UE should consider a cell that is incapable of supporting Category 0 as barred when in idle mode (see 3GPP RAN2 #85 and 3GPP RAN2 #85bis). The Cat.0 UE may consider the cell as barred even if the DL TBS does not exceed 1000 bits.

Mechanisms are provided which allow a UE to detect that it was admitted to a LTE cell where it is not properly supported. The UE can then go to idle mode and select a different suitable cell where it can be served. The following addresses the case of inter (but also intra) RAT mobility.

A method is shown in FIG. 3 of allowing UEs of a certain category, for example Cat. 0, to connect only to base stations, such as eNBs, that support that category. In step 1, information is received at a user equipment, said information indicative of whether a first cell supports the user equipment. After receiving the information, if the first information indicates that the first cell supports the user equipment, a connection procedure to the first cell is started. Alternatively, after receiving the first information, if the first information indicates that the first cell does not support the user equipment, the user equipment operates in idle mode. A UE may be connected to a source cell and the first cell may be a target cell. The UE may receive a handover (HO) command from a node such as a RNC and/or base station of the source network to handover to the target cell. The connection procedure may be Random Access (RA).

The information indicative of whether a first cell supports the user equipment may be received by a UE reading system information, for example a System Information Block (SIB) or any other suitable information broadcast or block. Information indicative of whether a first cell supports the user equipment may indicate whether the cell supports a particular category of UE. The information may, for example, comprise a bit and/or or a flag, such as a bit and/or a flag in a SIB, and/or may comprise any other suitable element for conveying the information.

FIG. 4 shows a timeline of an implementation of a method such as that shown in FIG. 3 for a Cat. 0 UE receiving a handover request to a target LTE cell. The UE may receive a handover (HO) command message from a RNC. For example, the UE may receive a HANDOVER FROM UTRAN COMMAND message. Before performing RA, a UE may read the SIBs of target cells. For example, prior to making a Random Access (RA) to an LTE cell, a UE, for example a Cat. 0 UE, may read the relevant System Information Block (SIB) to determine if the cell supports that category of UE. If the cell does not support the category of UE, UE does not perform RA and goes to idle mode. If the cell does support the category of UE, the UE begins a RA process for starting a connection procedure to the cell. In the example of FIG. 4, if the LTE Cells support Cat. 0 UE, the UE may perform RA. If the LTE Cells do not indicate the support of Cat. 0 UE, the UE does not perform RA, may go into idle mode, and therefore ignores a handover command.

Alternatively, or in addition, the information indicative of whether a first cell supports the user equipment may be received in a handover message. The information indicative of whether a first cell supports the user equipment may be, for example, a bit and/or flag, or any other suitable element in the handover message. Information indicative of whether a first cell supports the user equipment may indicate whether the cell supports a particular category of UE. For example, in a handover message sent by a source node, such as RNC or base station, to order a handover to a target Cell, the target cell may indicate as part of an inter-node RRC message whether it supports Category 0 UEs. If the UE is Cat. 0 and does not find the indication, it goes to idle mode and does not perform the handover.

FIG. 5 shows a timeline of an implementation of a method such as that shown in FIG. 3 for a Cat. 0 UE receiving a handover request to a target LTE cell. A UE may receive a handover (HO) command message from a RNC. For example, the UE may receive a HANDOVER FROM UTRAN COMMAND message. It may include the LTE message: RRCConnectionReconfiguration. If any of the messages received from the RNC contains an indication of support of Cat. 0 UE, the UE may begin a connection procedure to the target eNB. The indication of support may be a flag in the handover message. The connection procedure may be a RA process. If the message does not contain the indication of support of Cat. 0 UE, the UE may ignore the handover command and go to Idle mode.

FIG. 6 shows a timing diagram of a method wherein an aborted connection procedure, such as RA procedure, to a cell, for example eNB B, has taken place. That is, a UE has ignored a handover command and has gone to idle mode because it received an indication that it was not supported by a cell. A UE may connect to a second cell, such as eNB A, that supports the category of UE. During a further connection to a second cell that supports the UE, a UE may indicate to the second cell that that it did not start a connection procedure because a target cell, e.g. eNB B, did not support the UE. The UE may indicate to the second cell the Cell ID for the cell that did not support the UE, e.g. eNB B.

In a method such as the one shown in the timeline of FIG. 6, a Cat. 0 UE may abort a RA procedure to eNB B because it does not support Cat. 0 UE. The UE may perform a RA procedure to eNB A that supports Cat. 0 UE. When sending RRCconnectioncomplete message to eNB A, the UE may indicate that it has previously aborted a RA because the target cell did not support Category 0 UE. The UE may indicate the Cell ID of the aborted RA to eNB A.

FIG. 7a shows a method of an example in which a UE is connected to a first cell, such as a UMTS cell, and is being configured for measurements on a second type of cell, for example LTE cells. Before including the measurements in a report message, a UE may receive information indicative of whether the second type of cell supports the user equipment. In a first step a measurement request for a first cell is received at a user equipment. Information may be received at the user equipment, said information indicative of whether the first cell supports the user equipment. After receiving the first information, if the first information indicates that the first cell supports the user equipment, measurements for the first cell are caused to be reported. Alternatively, after receiving the first information, if the information indicates that the first cell does not support the user equipment, the lowest possible quality for the cell is caused to be reported. A measurement request may be received from a node for the first cell. The measurements or lowest possible quality may be reported to a node for the first cell. The information indicative of whether a first cell supports the user equipment may be received by a UE reading system information, for example a System Information Block (SIB) or any other suitable information broadcast or block. In one example, the UE may read the SIB of LTE cells before reporting the measurement result. If the cell supports the category of UE, the UE indicates the actual measurements. If the cell does not support the category of UE, the UE indicates the lowest possible quality of the cell in the report. The measurements may be radio quality measurements.

In the timing diagram shown in FIG. 7b, a Cat. 0 UE is configured for measurement on LTE by a RNC. The UE may read the SIB of the LTE cell it has to measure. If the LTE cell indicates in the SIB that it supports Cat. 0 UE, the UE may report the measurements that it has taken on the cell to the RNC. If the cell does not indicate the support of Cat. 0 UE in the SIB, the UE may report the lowest possible quality for the cell to the RNC.

The methods described above may help to avoided HO confusion (e.g., ping-pong effects) for a low-cost UE, e.g. a Cat. 0 UE, in the case of inter or intra-RAT HOs.

It should be understood that each block of the methods of FIGS. 3 to 7 and any combination thereof may be implemented by various means or their combinations, such as hardware, software, firmware, one or more processors and/or circuitry.

The method may be implemented on a control apparatus as shown in FIG. 8. FIG. 8 shows an example of a control apparatus for a communication system, for example to be coupled to and/or for controlling a station of an access system, such as a base station or (e) node B, or a server or host. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 109 can be arranged to provide control on communications in the service area of the system.

The control apparatus 109 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head. For example the control apparatus 109 can be configured to execute an appropriate software code to provide the control functions.

It should be understood that the apparatuses may include or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to Cat. 0 UEs and LTE, similar principles can be applied to any other communication system where UEs of a lower physical capability are supported by some networks and not by others. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they include program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), FPGA, gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1-41. (canceled)

42. A method comprising:
receiving first information at a user equipment, said first information indicative of whether a first cell supports the user equipment; and
operating the user equipment in idle mode if the first information indicates that the first cell does not support the user equipment, after receiving the first information.

43. The method according to claim 42, wherein the user equipment is connected to a source cell and the first cell is a target cell.

44. The method according to claim 43 comprising receiving a handover request from a node of the source cell to handover to the target cell.

45. The method according to claim 44, comprising receiving the first information as part of the handover request.

46. The method according to claim 42 comprising:
receiving a measurement request for the first cell; and
reporting lowest possible quality for the first cell if said first information indicates that the first cell does not support the user equipment, after receiving the first information.

47. The method according to claim 42, wherein receiving the first information comprises reading a system information block of the first cell.

48. The method according to claim 47, wherein the first information comprises a bit or a flag in the system information block.

49. The method according to claim 42 comprising, when the user equipment connects to a second cell, causing second information to be sent to the second cell, said second information indicative of an identity of the first cell.

50. An apparatus comprising
at least one processor;
and at least one memory including computer program code;
the at least one memory and the computer program code configured to, with the at least one processor, cause the apparatus at least to:
receive a measurement request for a first cell at a user equipment;
receive first information at the user equipment, said first information indicative of whether the first cell supports the user equipment; and
report a lowest possible quality for the first cell if said first information indicates that the first cell does not support the user equipment, after receiving the first information.

51. The apparatus according to claim 50, wherein said apparatus is connected to a second cell.

52. The apparatus according to claim 51, wherein the computer program code configured to, with the at least one processor, further cause the apparatus at least to:
receive the first information by reading a system information block of the first cell.

53. An apparatus comprising at least one processor;
and at least one memory including computer program code;
the at least one memory and the computer program code configured to, with the at least one processor, cause the apparatus at least to:
receive first information at a user equipment, said first information indicative of whether a first cell supports the user equipment; and
operate in idle mode if the information indicates that the first cell does not support the user equipment, after receiving the first information.

54. The apparatus according to claim 53, wherein said apparatus is connected to a source cell and the first cell is a target cell.

55. The apparatus according to claim 54, wherein the computer program code configured to, with the at least one processor, further cause the apparatus at least to:
receive a handover request from a node of the source cell to handover to the target cell.

56. The apparatus according to claim 55, wherein the computer program code configured to, with the at least one processor, further cause the apparatus at least to:
receive the first information as part of the handover request.

57. The apparatus according to claim 56 wherein the first information comprises a bit or a flag in the handover request.

58. The apparatus according to claim 53, wherein the computer program code configured to, with the at least one processor, further cause the apparatus at least to:
receive a measurement request for the first cell; and
report lowest possible quality for the first cell if said first information indicates that the first cell does not support the user equipment, after receiving the first information.

59. The apparatus according to claim 53, wherein the computer program code configured to, with the at least one processor, further cause the apparatus at least to:
read a system information block of the first cell.

60. The apparatus according to claim 59, wherein the first information comprises a bit or a flag in the system information block.

61. The apparatus according to claim 53, wherein the computer program code configured to, with the at least one processor, further cause the apparatus at least to:
when said apparatus connects to a second cell, cause second information to be sent to the second cell, said second information indicative of an identity of the first cell.
